(19) United States
(12) Patent Application Publication
(10) Pub. No.: US 2012/0330857 A1
(43) Pub. Date: Dec. 27, 2012

(54) Online Community Service

(76) Inventor: Adam Christopher Young, Rochester Hills, MI (US)

(21) Appl. No.: 13/165,691

(22) Filed: Jun. 21, 2011

(51) Int. Cl. G06Q 10/00; G06Q 90/00; G06Q 50/20

(52) U.S. Cl. 705/326; 705/1.1; 705/500

(57) ABSTRACT

A method for completing community service or serving the community voluntarily or as ordered by any authoritative or accredited body, such as a court Magistrate Judge, Public School System, Private School System, Scholarship Board, Probation Officer, Parole Officer, Officer of the Court, Deferment Program, Probation Program, Judicial Worker, Judge, District Attorney, Federal Attorney, Arbitrator, Mediator, Counselor, Case Worker, in lieu of fines, in lieu of jail time, in lieu of driver's license points or other repercussions and or suspensions, Magistrates, Clerks of the Court, Legal Aids, or any other type of court ordered community service online, on the internet, on the world wide web and or on mobile applications facilitated on computers, laptops, notebooks, mobile phones, tablets or any other type of input device that is user controlled and electronic in nature powered by electricity or connected by wireless signal or cable to other electronic devices.

### FIELD OF THE INVENTION

The present invention relates to the method of facilitating community service activities on the internet, world wide web, mobile phone, from home, on a computer or any other type of electronic device interconnected with another electronic device over wired or wireless signal or protocol. Specifically, the invention relates to completing required community service hours ordered by an authoritative body on an electronic device.

### BACKGROUND

Present day community service ordered by an authoritative body is traditionally defined as volunteering a persons time to a charitable organization for an agreed upon period of time to satisfy some type of obligation to society or an obligation to said authoritative body. The activities accomplished during the ordered volunteer time frame is at the sole discretion of the charitable organization.

It is increasingly difficult for citizens to complete required community service through traditional charity outlets due to rising liability insurance costs and a poor economy. Allowing citizens to complete their required community service online through our proprietary technology, citizens can fulfill their obligation to society in a manor that is convenient to their schedule without putting their livelihood in jeopardy.

While most activities volunteers are ordered to complete by charitable organizations for their required community service could be completed at any time, most programs require supervision of the citizen. Our proprietary technology removed all liability and time constraints from the citizens and their sponsoring charitable organizations. The technology supervises the user at all times and maintains a secure record of all their activities and the time they spent volunteering. By removing human supervision from the equation and allowing citizens to volunteer via electronic means, our invention provides a great service to society at large.

### SUMMARY OF THE INVENTION

The objective of the invention is to overcome the drawbacks and complications of traditional required or court ordered community service.

The invention provides a platform to facilitate traditional required or court ordered community service on an electronic device available to users at any day or time. The invention connects or places legal US citizens that have been required by an authoritative body to complete community service with charitable organizations that will sponsor their community service obligation.

The invention connects or places users with a charitable organization that is geographically closest to the citizen and provides them with tasks that, when completed, will fulfill their obligation to society, the charity and the order to complete community service. While participating in said tasks, the invention will track their time and record the volunteered time for access and verification at a later time. The tasks assigned to the citizen can vary, however, they are all delivered in some form of electronic communication. All directions and materials associated with said tasks are also delivered electronically.

### BRIEF DESCRIPTION OF THE DRAWINGS

Having thus described the invention in general terms, reference will now be made to the accompanying drawing, which are not necessarily drawn to scale, and wherein:

FIG. 1 is a flow chart illustrating a number of steps of a method according to one embodiment of the present invention.

### DETAILED DESCRIPTION OF THE INVENTION

The present invention now will be described more fully hereinafter with reference to accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

A citizen is first assigned community service time (FIG. 1A), usually in the form of days or hours but not limited to hours or days by any authoritative or accredited body including or voluntarily but not limited to: Federal Court System, District Court System, Circuit Court system including Circuit Court of Appeals, Supreme Court, Criminal Courts, Bankruptcy Courts, Tax Courts, Court of Veterans Appeals, State Court System, Probate Courts, Family Courts, Traffic Courts, Juvenile Courts, Small Claims Courts, Municipal Courts, Magistrate Judges, Trial Courts, Criminal Courts, Public School System, Private School System, Scholarship Boards, Probation Officers, Parole Officers, Officers of the Court, Juvenile Deferment Programs, Deferment Programs, Probation Programs, Judicial Workers, Judges, District Attorneys, Federal Attorneys, Arbitrators, Mediators, Councilors, Case Workers, In lieu or fines, in lieu of jail time, in lieu of drivers license points or other repercussions and or suspensions, Magistrates, Clerks of the Court, Legal Aids.

A citizen accesses the invention (FIG. 1B) by means of electronic device like a computer, laptop, mobile phone, tablet, or other type of electronic device that has access to the internet, world wide web or other type of interconnected network. The invention can be accessed by a web browser or other type of hyper text translation software through the universal record locator system.

The invention will then match, pair, place, or issue the citizen with a charitable organization, or electronic list of organizations, that the citizen can volunteer for. The invention will then issue the citizen tasks to complete for the time required by the authoritative body.

The invention will keep track and record the time segments the citizen spends volunteering their time for the charitable organization (FIG. 2A). The invention will transmit data to and from the charitable organization and to and from the citizen on behalf the charitable organization by means of electronic documents or signals transferred between multiple interconnected electronic devices, across wireless or wired networks, the internet, or the world wide web.

The invention will notify the authoritative body upon completion of the required community service obligation and provide the citizen with whatever information deemed necessary (FIG. 3A).

1. A method for completing community service or serving the community voluntarily or as ordered by any authoritative or accredited body, the Federal Court System, District Court System, Circuit Court system including Circuit Court of Appeals, Supreme Court, Criminal Courts, Bankruptcy Courts, Tax Courts, Court of Veterans Appeals, State Court System, Probate Courts, Family Courts, Traffic Courts, Juvenile Courts, Small Claims Courts, Municipal Courts, Magistrate Judges, Trial Courts, Criminal Courts, Public School System, Private School System, Scholarship Boards, Probation Officers, Parole Officers, Officers of the Court, Juvenile Deferment Programs, Deferment Programs, Probation Programs, Judicial Workers, Judges, District Attorneys, Federal Attorneys, Arbitrators, Mediators, Councilors, Case Workers, in lieu of fines, in lieu of jail time, in lieu of driver's license points or other repercussions and or suspensions, Magistrates, Clerks of the Court, Legal Aids, or any other type of court ordered community service online, on the internet, on the world wide web and or on mobile applications facilitated on computers, laptops, notebooks, mobile phones, tablets or any other type of input device that is user controlled and electronic in nature, powered by electricity or connected by wireless signal or cable to other electronic devices, facilitated through the means of education delivered in written, electronic, virtual, video, interactive form with or without testing, with or without review process, or any other task deemed worthy delivered by means of electronic signal through wireless or non-wireless means, mentor programs involving video chat, text based chat, email correspondence, correspondence by any electronic method involving the use of a signal through wireless or non-wireless transmission, creation of any electronic documents or intellectual property and or review of any electronic documents or intellectual property delivered by any means.

2. The method according to claim 1, wherein community service is facilitated by means of education wherein education is delivered by written form, video form, streaming media form, lecture form, class form, course form, in groups of coursework or singular course materials delivered by any electronic means or physical means.

3. The method according to claim 2, wherein education is provided by use of web portal, internet portal, website, world wide web, web 2.0 or future versions and styles of web 2.0 sites, internet page, hosted internet content, Internet media, or program designed to run on an interconnected network transmitted by electronic signal to single users or groups of users.

4. The method according to claim 3, wherein a web portal tracks educational program use by means of timer or clock or counting device, counting down or up, forward or backward in sequential standard or non-standard or non-sequential standard or non-standard measurements of time, and where time that is tracked is stored in a secured electronic facility for recall at a later time or transmission to another entity for verification.

5. The method according to claim 3, wherein a web portal is secured by means of user defined information, wherein users input designated credentials to access secured or unsecured content.

6. The method according to claim 2, wherein streaming media is defined by information transmitted by means of electronic signal via wireless or wired protocol over a period of time defined by the transfer rate of the media streaming.

7. The method according to claim 2, wherein educational materials, coursework, course materials, classes, courses and documents are defined as materials that deliver or contain information in any form to a user or group of users.

8. The method according to claim 1, wherein internet is defined by interconnecting networks that transmit data in any form over wireless or wired protocol.

9. The method according to claim 1, wherein communication is facilitated through a web portal via electronic means between a mentor and or protégé, or groups of mentors and or protégés.

10. A method for connecting, placing, matching or assigning users to a charity or charities to complete community service voluntarily or ordered by any authoritative or accredited body, the Federal Court System, District Court System, Circuit Court system including Circuit Court of Appeals, Supreme Court, Criminal Courts, Bankruptcy Courts, Tax Courts, Court of Veterans Appeals, State Court System, Probate Courts, Family Courts, Traffic Courts, Juvenile Courts, Small Claims Courts, Municipal Courts, Magistrate Judges, Trial Courts, Criminal Courts, Public School System, Private School System, Scholarship Boards, Probation Officers, Parole Officers, Officers of the Court, Juvenile Deferment Programs, Deferment Programs, Probation Programs, Judicial Workers, Judges, District Attorneys, Federal Attorneys, Arbitrators, Mediators, Councilors, Case Workers, in lieu of fines, in lieu of jail time, in lieu of driver's license points or other repercussions and or suspensions, Magistrates, Clerks of the Court, Legal Aids, or any other type of court ordered community service by means of automatic placement, electronic placement, manual placement or human placement facilitated through the internet, network, world wide web or interconnected electronic device over wireless signal or wired signal.

11. The method according to claim 10, wherein charities are assigned, connected, placed, matched or a relationship is created in some form with users through a web portal, web site, internet site or other electronic destination, by means of automation or human selection.

12. The method according to claim 10, wherein charities are partnered with individuals are given access to educational materials through a secured or unsecured web site or web portal accessible on the world wide web, internet or other network of interconnected electronic devices.

13. A method for providing information electronically on behalf of a charitable organization.

14. The method according to claim 13, wherein information is delivered to a user by means of electronic documents sent via electronic transmission wherein the source of the information is a charitable organization or is derived from a charitable organization, or is transmitted electronically from a charity or charitable organization.

15. A website or web portal hosted on the interne, World Wide Web or other network of interconnected electronic devices allowing access to the public designed to facilitate community service to fulfill a court order issued by an accredited or authoritative body, government entity or voluntarily community service.

16. The entity or agent of entity according to claim 15 includes but is not limited to: Federal Court System, District Court System, Circuit Court system including Circuit Court of Appeals, Supreme Court, Criminal Courts, Bankruptcy Courts, Tax Courts, Court of Veterans Appeals, State Court System, Probate Courts, Family Courts, Traffic Courts, Juvenile Courts, Small Claims Courts, Municipal Courts, Magistrate Judges, Trial Courts, Criminal Courts, Public School System, Private School System, Scholarship Boards, Probation Officers, Parole Officers, Officers of the Court, Juvenile Deferment Programs, Deferment Programs, Probation Programs, Judicial Workers, Judges, District Attorneys, Federal Attorneys, Arbitrators, Mediators, Councilors, Case Workers, in lieu of fines, in lieu of jail time, in lieu of driver's license points or other repercussions and or suspensions, Magistrates, Clerks of the Court, Legal Aids or voluntarily or ordered by any authoritative or accredited body.

17. The public according to claim 15 is defined as an individual human being that resides on the planet, Earth.

18. A method for facilitating community service involving the delivery of educational materials to users through electronic means over wireless or wired signal through interconnecting devices.

19. The method according to claim 18, wherein community service is defined by volunteering time to a charitable organization.

20. The method according to claim 18, wherein volunteering time is defined by doing some type of activity without being compensated in any way, shape, or form.

21. A method for delivering a list of charitable organizations, non-profits, charities and other outlets for community service via electronic communication delivered between two or more interconnected electronic devices.

22. The method according to claim 21, wherein a list of community service outlets is sent to a list of potential volunteers via electronic communications facilitated over wireless or wired communications in single transmission or multiple subsequent transmissions over a period of time or periods of time.

23. The method according to claim 22, wherein a list of community service outlets is provided in electronic format by electronic transmission between two interconnected devices facilitated over wired or wireless protocols.

24. A method for facilitating fund raising donations in lieu of volunteer hours or in place of volunteer hours for voluntary community service or community service required by an authoritative or accredited body.

25. The method according to claim 24, wherein a monetary exchange initiated on the internet, online, on a website, web portal, web 2.0 or future classifications, between the invention, citizen performing volunteering duties, and the charitable organization sponsoring said volunteer takes place for credit of community service time.

26. The method according to claim 25, wherein volunteering credit is provided for a specific period of time in exchange for a monetary instrument

27. A method for tracking and organizing clients and volunteers by referring entity allowing overseeing parties to review volunteers' progress and provide access to all information transmitted by invention from charitable organizations to overseeing parties.

28. A method for electronically monitoring volunteers while completing assigned tasks for a charitable organization.

29. A method for completing community service comprising the steps of:
(a) an individual appearing before an authoritative body and pleading the reasons for the presence of said individual before said authoritative body;
(b) said authoritative body hearing said individual's pleading; and
(c) said authoritative body making a determination that in lieu of fines or jail time ordering said individual to perform online community service.

30. The method for completing community service of claim 29, wherein said authoritative body is selected from a group consisting of the Federal Court System, District Court System, Circuit Court system including Circuit Court of Appeals, Supreme Court, Criminal Courts, Bankruptcy Courts, Tax Courts, Court of Veterans Appeals, State Court System, Probate Courts, Family Courts, Traffic Courts, Juvenile Courts, Small Claims Courts, Municipal Courts, Magistrate Judges, Trial Courts, Criminal Courts, Public School System, Private School System, Scholarship Boards, Probation Officers, Parole Officers, Officers of the Court, Juvenile Deferment Programs, Deferment Programs, Probation Programs, Judicial Workers, Judges, District Attorneys, Federal Attorneys, Arbitrators, Mediators, Councilors, and Case Workers.

31. The method for completing community service of claim 29, wherein said ordered community service is done with a method selected from a group consisting of online, via the Internet, via the World Wide Web, and via a mobile application.

32. The method for completing community service of claim 29, wherein said ordered community service is facilitated via a group selected from a computer, a laptop, an electronic notebook, a mobile phone, an electronic tablet, and an input device that is user controlled and electronic in nature, powered by electricity or connected by wireless signal or cable to other electronic devices.

33. The method for completing community service of claim 29, wherein said ordered community service is facilitated through a means selected from a group consisting of an education lesson delivered in written, electronic, virtual, video, interactive form, and delivered by means of electronic signal through wireless or non-wireless means, mentor programs involving video chat, text based chat, email correspondence, correspondence by any electronic method involving the use of a signal through wireless or non-wireless transmission, creation of any electronic documents or intellectual property and or review of any electronic documents or intellectual property delivered by any means.

34. The method according to claim 29, wherein said community service is facilitated by means of education lesion, and wherein said education lesson is delivered in written form, video form, streaming media form, lecture form, class form, course form, in groups of coursework, and in singular course material form delivered by any electronic means or physical means.

35. The method according to claim 29, wherein an education plan is provided by use of web portal, internet portal, website, world wide web, web 2.0 or future versions and styles of web 2.0 sites, Internet page, hosted Internet content, Internet media, and Program designed to run on an interconnected network transmitted by electronic signal to single users or groups of users.

36. The method according to claim 29, wherein a web portal tracks educational program use by means selected from a group consisting of timer, clock, counting device, counting down or up device, forward or backward in sequential standard or non-standard or non-sequential standard or non-standard measurements of time, and where time that is tracked is stored in a secured electronic facility for recall at a later time or transmission to another entity for verification.

37. The method according to claim 29, wherein a web portal is secured by means of user defined information, and wherein a user inputs designated credentials to access secured or unsecured content.

38. The method according to claim 29, wherein streaming media is defined by information transmitted by means of electronic signal via wireless or wired protocol over a period of time defined by the transfer rate of the media streaming.

39. The method according to claim 29, wherein educational materials, coursework, course materials, classes, courses and documents are defined as materials that deliver or contain information in any form to a user or group of users.

40. The method according to claim 29, wherein internet is defined by interconnecting networks that transmit data in any form over wireless or wired protocol.

41. The method according to claim 29, wherein communication is facilitated through a web portal via electronic means between a mentor and said individual, or a group of mentor and said individual.
